(19) United States
(12) Patent Application Publication
(10) Pub. No.: US 2011/0215208 A1
(43) Pub. Date: Sep. 8, 2011

(54) MUSICAL INSTRUMENT SUPPORT STAND

(76) Inventor: Anthony J. Campagna, Carlsbad, CA (US)

(21) Appl. No.: 13/043,378

(22) Filed: Mar. 8, 2011

Related U.S. Application Data
(63) Continuation-in-part of application No. 11/751,570, filed on May 21, 2007, now Pat. No. 7,900,881.

(51) Int. Cl. G10G 5/00; B23P 11/00

(52) U.S. Cl. 248/158; 29/428

(57) ABSTRACT

A stand for a musical instrument is sturdy, durable and easy to construct. The stand supports a musical instrument, such as a guitar, in a substantially upright, readily accessible manner. In one embodiment, the stand is easy to disassemble for ready transport or store in a low volume configuration. One variant of a stand includes a base for supporting a lower section of a musical instrument and a detachable neck that engages an upper section of the musical instrument, and which may optionally be articulated. The base includes a front support rod, a back support rod spaced apart and extending parallel to the front support rod and a pair of side support rods extending between and connecting the front support rod and the back support rod. A plurality of legs extend from the base to provide stability. The neck support can be magnetically secured to the base in a substantially upright position when the stand is in an assembled configuration. When in a storage configuration, the neck support can be secured to base in a horizontal position, thereby providing a low profile.

### PRIORITY

This application is a continuation-in-part (CIP) of U.S. patent application Ser. No. 11/751,570 filed May 21, 2007 of the same title, to be issued as U.S. Pat. No. 7,900,881, which is incorporated herein by reference in its entirety.

### BACKGROUND

1. Technical Field

Embodiments of the present invention relate to a musical instrument support stand. In particular, some embodiments relate to a readily transportable support stand for storing and displaying instruments, such as guitars, violins, violas, basses, banjos and the like.

2. Description of Related Art

Musicians are often faced with the challenge of temporarily supporting their instrument when it is not being played. Instruments such as guitars are subject to potential damage if simply laid flat on the floor, so it is common practice to lean the neck or head of the instrument against a piece of furniture or a wall.

Leaning the neck of such an instrument against a piece of furniture or the like often results in the upper part of the instrument sliding laterally, causing the entire instrument to fall to the floor, again resulting in damage to the instrument. Leaning the head of such an instrument against a wall or a piece of furniture has the added disadvantage of potentially putting the instrument out of tune due to the tuners in the head coming in contact with the wall or furniture.

Conventional musical instrument stands serve simply to sustain the musical instrument. Therefore, no provision for convenience in storing and carrying the musical instrument is made in the conventional stands. Additionally, the stands cannot even sustain the musical instruments stably.

That is, the conventional musical instrument stands are inconvenient in storing and carrying musical instruments because of the weights and sizes of the stands, and cannot sustain musical instruments stably due to the insufficient holding structures of the stands. In addition, many conventional stands tend to be bulky and not collapsible; consequently, they tend to be difficult to store and transport.

### BRIEF SUMMARY OF EMBODIMENTS OF THE INVENTION

Accordingly, embodiments of the present invention have been made to overcome the problems associated with conventional stands. In accordance with various embodiments of the present invention, a musical instrument stand is provided that can be easily assembled, disassembled and stored. In addition, these stands can also be readily transportable and sturdy.

According to one embodiment of the present invention, a stand configured to hold a musical instrument has a base and a support neck. The base includes a front support member and a back support member spaced apart from the front support member and extending substantially parallel to the front support member. A first side support member is located on one side of the base and connects the front support member to the back support member. In addition, a second side support member is located on the other side of the base, which also connects the front support member to the back support member. The support neck has a first end configured to be fastened to the base and a latch configured to detachably engage a musical instrument held in the stand.

According to another embodiment of the present invention, a stand for a musical instrument supports a musical instrument, such as a guitar, in a substantially upright, readily accessible manner, yet the stand is easy to disassemble for ready transport or store in a low volume configuration.

According to a further embodiment, a stand for a musical instrument includes a base for supporting a lower section of a musical instrument and a detachable neck that engages an upper section of the musical instrument. The base includes a front support rod, a back support rod spaced apart and extending parallel to the front support rod and a pair of side support rods extending between and connecting the front support rod and the back support rod. A plurality of legs extend from the base to provide stability. The neck support can be magnetically secured to the base in a substantially upright position when the stand is in an assembled configuration. The neck support can be secured to the base in a horizontal position when the base is in a storage configuration. In one embodiment, the neck support is magnetically secured to base in the storage configuration.

According to another aspect of the invention, an instrument stand with an articulated mating or head assembly is disclosed. The articulated assembly advantageously allows the instrument to be held at varying angles and positions.

According to another aspect of the invention, and articulated head assembly is disclosed. In one embodiment, the head assembly comprises a magnetic element held by a pivot ball and spring assembly on the end of a substantially vertical removable neck element.

According to another aspect of the invention, methods and apparatus for utilizing a stand are disclosed. In one embodiment, a removable element (e.g., ferrous or Velcro strip) is mated or adhered to the musical instrument back, and a complementary attachment mechanism (e.g., magnet, Velcro, etc.) mates thereto when the instrument is placed on the stand. This approach allows, inter alia, instruments without an indigenous metallic component to be held securely in the stand.

According to another aspect of the invention, methods and apparatus for stacking multiple instrument stands are disclosed.

According to another aspect of the invention, a multi-instrument stand is disclosed.

According to another aspect of the invention, a web sling or cradle for an instrument (e.g., acoustic guitar) for use with the stand is disclosed.

Other features and aspects of the invention will become apparent from the following detailed description, taken in conjunction with the accompanying drawings, which illustrate, by way of example, the features in accordance with various embodiments of the invention.

### BRIEF DESCRIPTION OF THE DRAWINGS

FIG. 1 is a front view of a support stand in an assembled configuration in accordance with one embodiment of the present invention.

FIG. 2 is a side view of the support stand of FIG. 1.

FIG. 3 is an elevated front view of the support stand of FIG. 1 in an unassembled configuration.

FIG. 4 is a front view of the support stand of FIG. 1 holding a guitar.

FIG. 5 is a side view of the support stand of FIG. 1 holding a guitar.

FIG. 6 is a back view of an embodiment of a support stand holding a guitar without the use of a support neck in accordance with one embodiment of the present invention.

FIG. 7 illustrates the support stand of FIG. 1 in a storage configuration.

FIG. 8 illustrates one embodiment of an articulated head for use with the stand of the invention.

FIG. 9 illustrates one embodiment of a stand configured with a sling or cradle according to one embodiment of the invention.

FIG. 10 illustrates one embodiment of stands configured for stacking.

It should be understood that the above exemplary Figures are not necessarily drawn to scale. Certain proportions thereof may be exaggerated, while others may be minimized. The figures are intended to illustrate various embodiments of the invention that can be understood and appropriately carried out by those of ordinary skill in the art.

### DETAILED DESCRIPTION OF EXEMPLARY EMBODIMENTS OF THE INVENTION

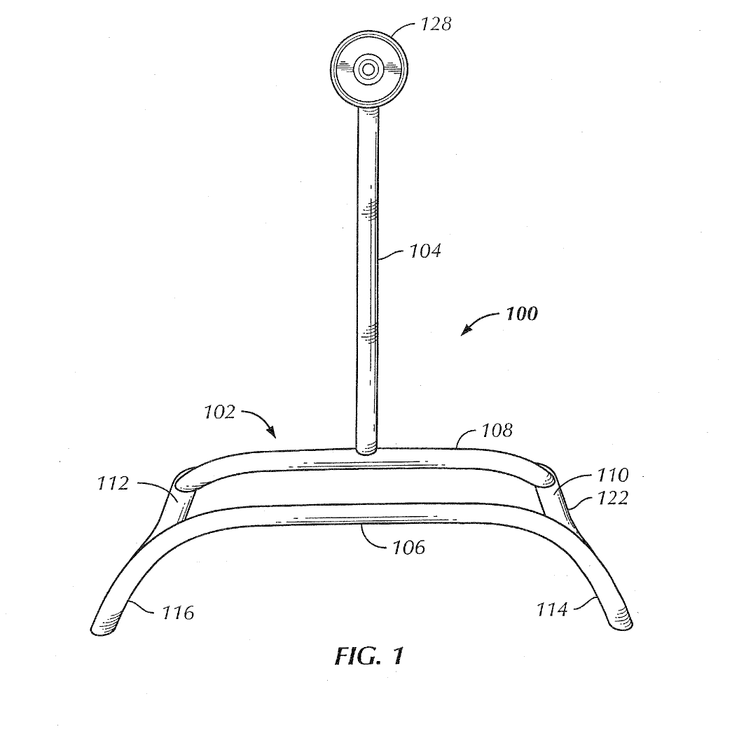

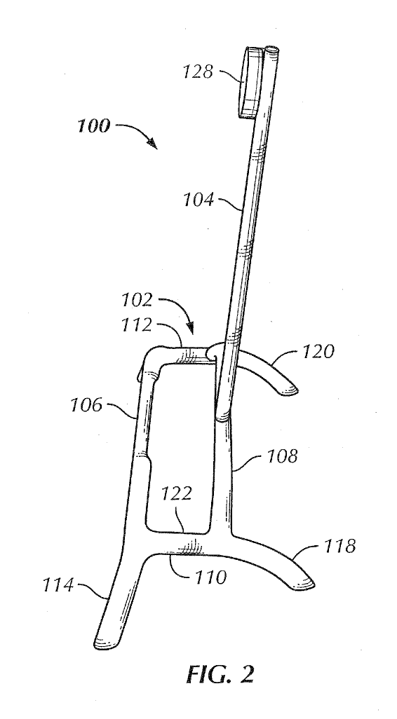

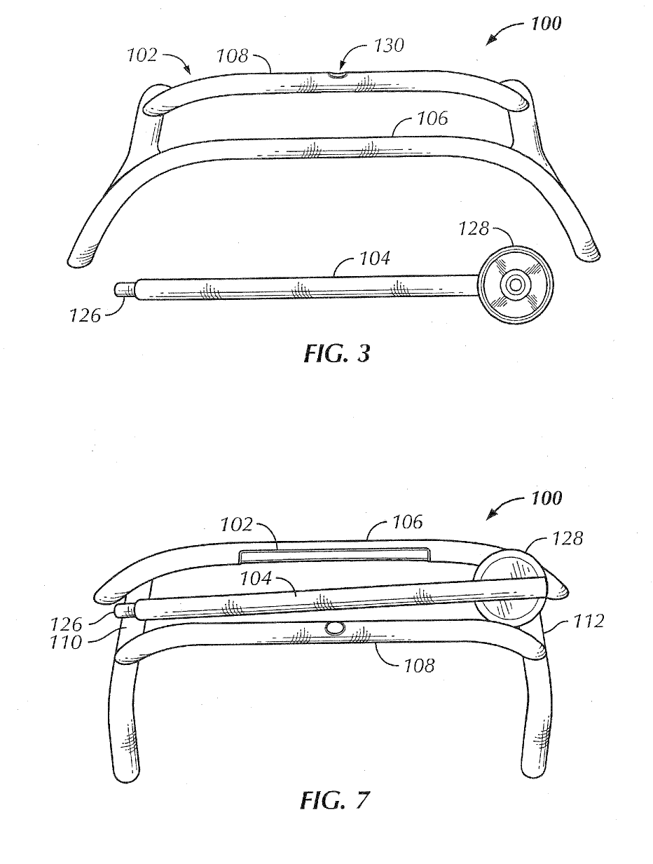

Referring now to the drawings, FIGS. 1 and 2 are respective front and side views of an embodiment of a stand 100 in an assembled configuration, and FIG. 3 is an elevated front view of the stand 100 in an unassembled configuration. The components of the stand 100 include a base 102 and a detachable support neck 104. The base 102 can include a front support 106 spaced apart and extending parallel to a rear support 108. First side support 110 and second side support 112 can connect the front support 106 and the rear support 108. The side supports 110 and 112 can also extend parallel to one another as well as be recessed relative to the top surfaces of the front and rear supports 106 and 108. In one embodiment, the side supports 110 and 112 are sufficiently recessed relative to the front and rear supports 106 and 108 so as to permit a guitar to be recessed with in the stand, but not recessed to the extent that knobs or other components of a guitar hit against the front support 106 or rear support 108 when the guitar is placed in the stand 100. The base 102 can also include a pair of front legs 114 and 116 (FIG. 1) and a pair of rear legs 118 and 120 (FIG. 2). Advantageously, the base 102 can have a low profile, yet also have a wide enough base for providing stability to the stand 100. A low profile can be beneficial in that the stand 100 does not unnecessarily consume space on a music store floor or stage, for example.

With further reference to FIGS. 1 through 3, the front support 106 and the pair of front legs 114 and 116 can be a single, curved rod. Similarly, the first side support 110 and the rear leg 118 can be a single curved rod and the second support 112 and the rear leg 120 can be a single curved rod, with each of the curved rods fastened at one end to the front support 106. The back support 108 can also be a single curved rod fastened at its ends to the first and second side supports 112 and 118. In one embodiment, the various sections of the base 100 are metal and welded together, but other known methods of fastening can also be used to either fasten the various sections together in a permanent or non-permanent fashion.

The base 102 can also include a notch 122 formed in one of the side supports 110 or 112. In the embodiment shown in FIGS. 1 and 2, the notch 122 is formed in the first side support 110, but in other embodiments, the notch can be formed in the second side support 112 or the notch 112 can be omitted. As described in more detail below, the notch 122 can serve to accept a cord attached to a guitar as well as serve to accept a section of the support neck 108 when the stand 110 is in a storage configuration. As also shown in FIG. 2, the front support 106 includes a cut-out section near the center portion of the front support 106, which is designed to accommodate the bridge of some guitars, for example, when placed into the stand.

In various embodiments, the support neck 104 can be detachably secured to the base 100. In other embodiments, the support neck 104 is permanently affixed to the base 100. In the embodiment shown in FIGS. 1 and 2, the support neck 104 extends not quite vertically from the base 100 in a slightly reclined stance. In this manner, a guitar held in the stand 100 can also have a slightly reclined stance.

Referring again to FIGS. 1 and 2, the support neck 104 can include a latch 128 located at an upper end of the support neck 104. The latch 128 can serve to fasten a portion of a guitar to the support neck 104. In accordance with various embodiments, the latch 128 has magnetic properties capable of having a strong engagement with, for example, a ferrous metal neck plate affixed to a guitar, as is explained in greater detail below. The latch 128 can include neodymium other known materials having suitable magnetic properties.

In various embodiments, the latch 128 can also include glow-in-the-dark material applied to its surface so that the latch 128 can be seen on a dark stage, for example. In addition, the glow-in-the-dark material can be in the form of a design or logo for advertising purposes.

In other embodiments, the latch 128 need not be magnetic. Instead, the latch 128 can be any other suitable type of latching mechanism configured to releasably secure a guitar to the support neck 104. In further embodiments, the latch 128 can be omitted so that a guitar held in the stand 100 merely rests against the support neck 104. In such embodiments, an abutment may be provided on the support neck 104 configured to support an upper portion of a guitar held in the stand 100.

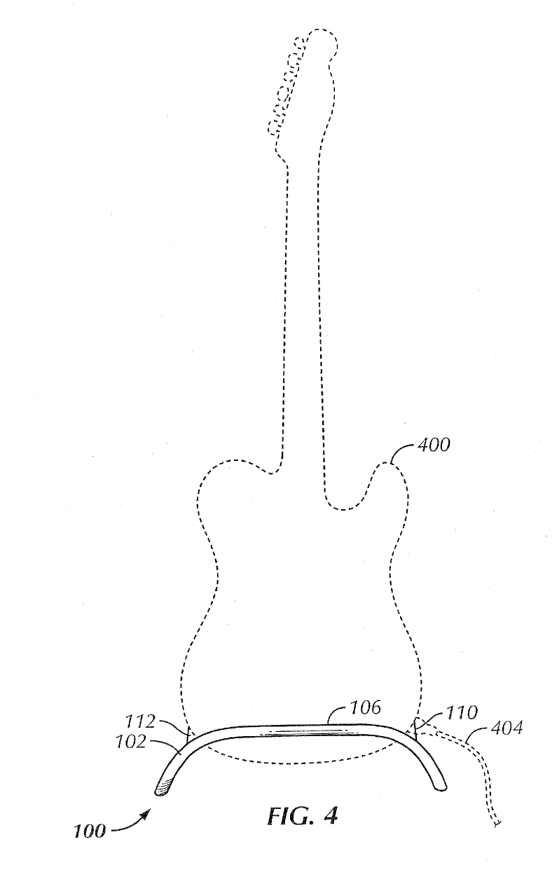

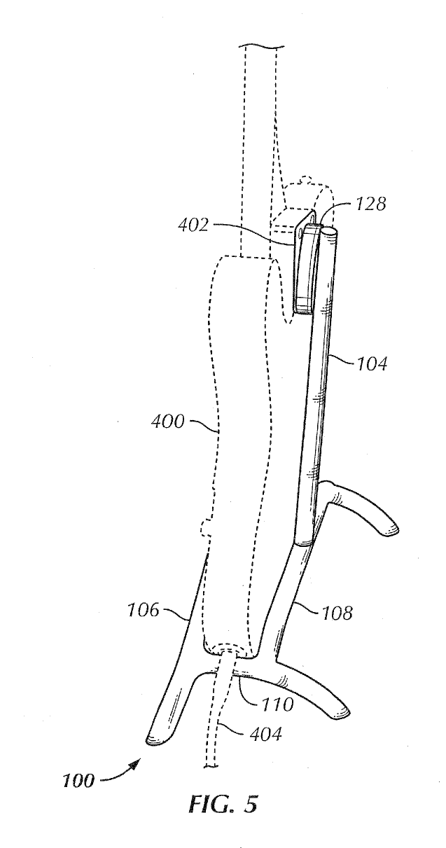

FIG. 4 is a front view of the stand 100 holding a guitar 400 and FIG. 5 is a back view of the stand 100 holding the guitar 400 in accordance with one embodiment of the present invention. As shown, the base 102 can support a lower portion of the guitar 400 and the support neck 104 can support an upper portion of the guitar 400. Specifically, the first side support 110 and second side support 112 support respective lower sides of the guitar 400. In addition, the rear support 108 supports a lower back portion of the guitar 400 and the front support 106 supports a lower front portion of the guitar 400. The latch 128 can be fastened to a metal neck plate 402 (FIG. 5) that is affixed to the back of the guitar 400. Also, when a cord 404 is attached to the guitar 400, a portion of the cord 404 can sit in the notch 122. Accordingly, the stand 100 can securely hold the guitar 400 in place in the above-described manner.

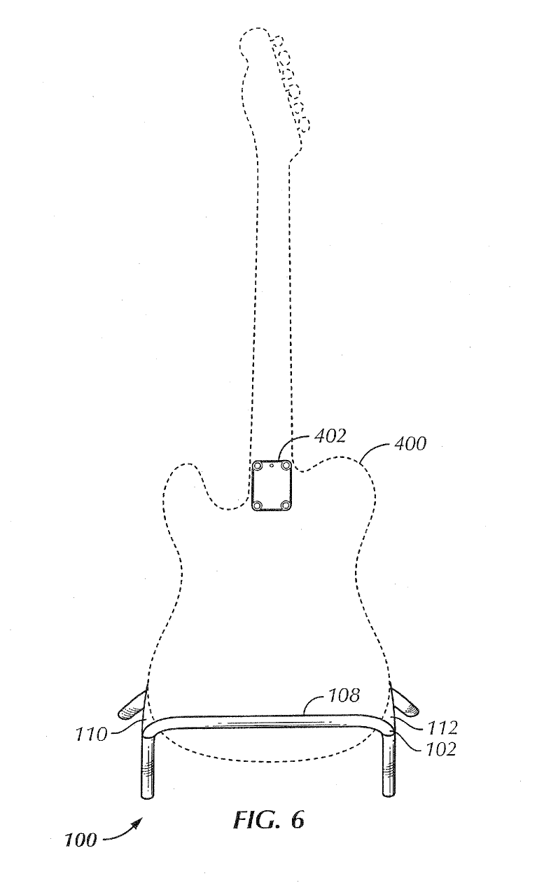

As is known, some guitars are manufactured with a metal neck plate affixed to the back of the guitar, such as the neck plate 402 illustrated in FIGS. 5 and 6. However, for guitars that do not have a metal neck plate, a neck plate can be affixed to the guitar. Alternatively, a ferrous sticker can be applied to the guitar for providing a section for magnetically fastening the guitar to the latch 128. Such magnetic stickers are well known. Of course, other methods of affixing a suitable surface to the guitar for engagement with a magnetic latch can also be used.

Referring again to FIG. 3, the support neck 104 can be disengaged from the base 102. As can be seen, the support neck 104 includes a pin 126 at an end of the support neck 104. The pin 126 can be a reduced diameter section of the support neck 104 configured to fit inside a hole 130 formed in an upper surface of the rear support 108. The pin 126 can have a friction fit with the hole 130. In one embodiment, the pin 126 also has magnetic properties, which further secures the support neck 104 to the base 102. To assemble the stand 100, the support neck 104 can be secured to the base 102 by positioning the latch 128 facing forward and placing the pin 126 in the hole 130.

In one embodiment, magnetic materials used in the pin 126 and the base 100 are selected such that a user need only grip the guitar neck with one hand to pick up and move the stand 100 and the guitar 400 together. This can be advantageous when it is desired to move the stand 100 and guitar 400 together, such as when vacuuming under the stand 100 or when moving the stand to a different location on a stage, for example. Furthermore, since a user need use only one hand to move the stand 100 and guitar 400, the other hand is free to carry other objects, such as a vacuum or an additional musical instrument. Suitable magnetic materials to be used in the pin 126 can include neodymium or other known materials having suitable magnetic properties.

In one embodiment, to remove the support neck 104 from the base 102, a user can place his or her foot on the base 102 and pull the support neck 104 in a generally upward direction. As is understood, the amount of force required to remove the support neck 104 from the base 102 can depend upon the magnetic attraction between the pin 126 and the base 100.

Placing the guitar 400 in the stand 100 and removing the guitar 400 from the stand is described with reference to FIGS. 4 and 5. A user can place the guitar 400 in the stand 100 by placing a bottom portion of the guitar 400 between the front support 106 and rear support 108. The user can then recline the back of the guitar 400 against the latch 128 so that the latch 128 engages the neck plate located on the back of the guitar 400. To remove the guitar 400 from the stand, a user can place a foot on the base 102 and pull the guitar 400 away from the latch 128. Once the guitar 400 is released from the latch 128, the user lifts the guitar 400 out of the base 102 in a generally upward direction.

In one embodiment, the base 102 can hold the guitar 400 without the use of the detachable support neck 104. FIG. 6 is a back view of the base 102 supporting the guitar 400 without the use of a neck support 104 in accordance with one embodiment of the present invention. As shown, the first side support 110 and second side support 112 support respective sides of the guitar 400. In addition, the rear support 108 supports a back portion of the guitar 400 and the front support 106 supports a front portion of the guitar 400. When a user positions the guitar 400 into the base 102, the user can recline the guitar 400 towards the rear of the base 102 so that the front portion of the guitar 400 is leveraged against the front support 106 and the back portion of the guitar 400 is leveraged against the back support 108. In this manner, the base 102 can securely hold the guitar 400 in a slightly reclined, upright stance.

FIG. 7 shows the stand 100 in a storage configuration in accordance with one embodiment of the present invention. In the storage configuration, the stand 100 can be easily transportable and can be conveniently stacked on top of other stands. To place the stand 100 in the storage configuration, the support neck 104 can be positioned across the base 102, between the front support 106 and rear support 108, with the latch 128 contacting the second side support 112 and the pin 126 contacting the first side support 110. Advantageously, the latch 128 is magnetically fastened to the second side support 112 and the pin 126 is magnetically fastened to the first side support 110. In addition, the pin 126 can be located in the notch 122 (FIGS. 1 and 2). In one embodiment, the support neck 104 has sufficient magnetic attraction to the base 102 so that a user need only grasp the support neck 104 to carry the stand 100 while in its storage configuration.

In accordance with various embodiments of the present invention, the non-magnetic sections of the base 102 and support neck 104 can be made of a wide variety of materials, including plastic, metal, wood, or the like. In addition, all or a portion of the base 102 and support neck 104, including any magnetic portions, can be encapsulated with a dampening material. The dampening material can serve to cushion a guitar held in the stand 100, as well as reduce the likelihood of damaging a guitar when the guitar is placed in the stand 100. The dampening material can also provide durability to the stand 100 and can reduce the likelihood of damage caused by the stand 100 hitting other objects (e.g. cars, upholstery, walls and flooring) during transport. The dampening material can be a plastic or rubberized material. In one embodiment, the stand 100 is encapsulated with a lining supplied by Rhino Linings USA Inc. It is understood, however, that any suitable rubber, plastic, cloth or other type of material, or combination of materials, capable of providing a cushion and/or protective layer completely or at least partially covering the stand may be utilized in accordance with the present invention.

### Alternate Embodiments

In another embodiment, the musical stand includes a pivoting or articulating member (e.g., head on the end of the vertical riser or support neck). This pivoting member mates with a complementary portion of the musical instrument (e.g., a metal plate, applied mating surface (discussed below), etc.), thereby allowing the pivoting member to be removably attached to the instrument, which aids in holding the instrument in place on the stand. The pivoting member advantageously allows for the support neck or riser to be disposed at various angles relative to the musical instrument (and its mating surface, which may have a different orientation than that of the back of the musical instrument as a whole), and still maintain sufficient retraining force on the instrument.

It will be appreciated that with a substantially planar magnet of the type previously described herein, it may be the case that the musical instrument sits in the stand so that the planar magnet face is disposed at an angle with the magnetic or metallic surface of the back of the instrument, and hence the magnet head will not exert its full magnetic pull on the instrument properly. The articulated or pivoting head of the present embodiment allows the head to assume a wide range of angles relative to the riser/neck, so as to accommodate many different configurations or angles of the back (mating) surface of the instrument. It also permits different attitudes or orientations of the neck (e.g., from vertical) if desired, such as where the neck has a multi-position adjustment mechanism where it meets the base, or along its length (e.g., a joint in the middle portion of the neck riser).

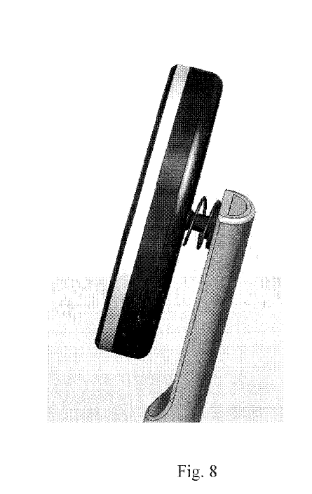

In one variant, a spring and ball arrangement such as that shown in FIG. 8 is used to provide for the articulation of the head. The ball allows the magnet/head to articulate over a wide range of angles, while the spring, inter cilia, helps bias the head against the ball so that the head does not “flop” or move unduly relative to the neck due to gravity acting on its own mass, or during movement of the components.

It will further be appreciated that the head need not be magnetic, but rather may comprise other forms of removable attachment to the musical instrument, such as e.g., Velcro®, a mechanical frictional or snap or latch arrangement, removable adhesives, and so forth. The articulation previously described may also be afforded by this removable attachment itself (as opposed to the articulated head), such as where the removable attachment mechanism comprises a ball-and-socket, the ball (e.g., on the riser) snapping into a socket formed on the back of the instrument.

The articulated head may also have a logo (e.g., for the musical instrument manufacturer, a band, etc.) or other indicia on the face of the magnet (or its housing) so that it may be viewed when the instrument is removed from the stand. This may be different in texture, color, luminosity, reflectivity, fluorescence, or any other desired property, as compared to its surroundings, so as to make it more readily discerned under varying light or other conditions.

In yet another embodiment, the various embodiments of the stand described supra may be fashioned as double- or even triple- or quad-stands, so that multiple instruments may be held simultaneously if desired. In one variant, the instruments are held in a juxtaposed or side-by-side disposition. In another variant, the multiple instruments are “stacked” in a front-to-back line disposition. In still another variant, the multiple instruments are “stacked” in a back-to-back or front-to-front (mirror image) disposition; i.e., so that the multiple instruments face each other, or face outward opposing one another. Yet other dispositions and/or combinations of the foregoing will be appreciated by those of ordinary skill given the present disclosure.

In yet another variant, the stand is configured so that the user can interchange or add multiple risers/necks (e.g., with the aforementioned articulated head if desired) so that a given base configuration is expandable by the user. The base of the stand may have pre-made receptacles for these additional necks if desired (which may be capped or otherwise obfuscated while not in use).

Yet other embodiments of the invention contemplate use of a no-skid or similar pad for use on the floor or other surface beneath the stand, so that an instrument such as an acoustic guitar is kept from sliding on the surface, and potentially damaging it by disengaging the instrument from the articulated head due to gravity and momentum of the sliding instrument. (or where no mating head is used, such as when the instrument has no mating element or plate on its back.

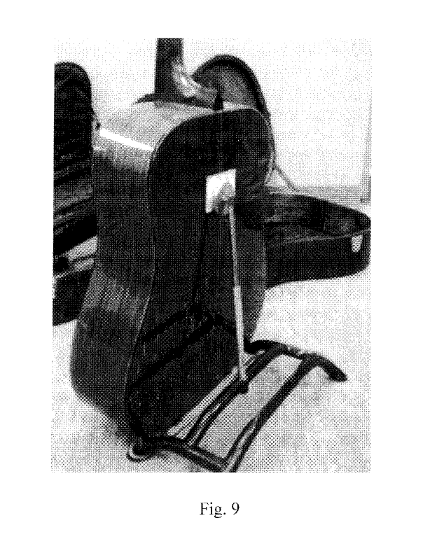

In a further embodiment, a web or sling is used in conjunction with the base of the stand to receive the bottom of the instrument (rather than have the base of the instrument rest on the crossbar of the stand base, or on the floor in other implementations). In one such variant, the web or sling comprises an elastomeric material such as a rubber, which is strung across and attached to the front two outer legs of the stand base (see FIG. 9). The base of the instrument then sits cradled and suspended in the sling, off the floor.

In another embodiment, rather than utilizing a metallic or magnetic plate or structure of the musical instrument itself (some instruments do not have such components), an applied element is used. In one variant, a static charge plastic sticker or other such removable applied element is applied to the instrument, the applied element allowing for mating to the articulated head. The applied element may be e.g., ferrous, or may be itself magnetic (somewhat akin to a flexible refrigerator magnet), so that the applied element and neck head will exert a binding force with each other when placed in sufficient proximity. Alternatively, the applied element might use a removable adhesive or “sticky” surface to adhere to the musical instrument without damage. Numerous such adhesives are well known to those of ordinary skill in the art, and hence not described further herein.

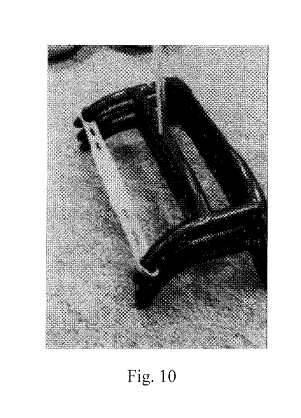

In yet another embodiment, the stand is made vertically stackable with other similar stands, so that they take up less space, and are easily transportable (see FIG. 10). Individual ones of the stands may also be made to interlock with one another, so as to form a common structure (e.g., multi-instrument stand). For example, in one such variant, two single-instrument stands (e.g., each having a first crossbar for supporting the instrument, and a second crossbar for receiving the vertical neck) may be stacked, the top stand being rotated 180-degrees relative to the lower stand, so that the two apertures for the necks are both exposed (albeit at different heights). The aforementioned web or sling may then be used on each stand to cradle the base of the instruments, thereby forming a two-instrument stand.

While various embodiments of the present invention have been described above, it should be understood that they have been presented by way of example only, and not of limitation. Thus the breadth and scope of the present invention should not be limited by any of the above-described exemplary embodiments. Additionally, the invention is described above in terms of various exemplary embodiments and implementations. It should be understood that the various features and functionality described in one or more of the individual embodiments are not limited in their applicability to the particular embodiment with which they are described, but instead can be applied, alone or in some combination, to one or more of the other embodiments of the invention, whether or not such embodiments are described and whether or not such features are presented as being a part of a described embodiment.

For example, although much of this disclosure describes use of the stand 100 in terms of holding the guitar 400, other types of guitars, including both electric and acoustic guitars, can be used with embodiments of the present invention. Moreover, as should be understood, guitars vary in size. Accordingly, the dimensions of the stand 100 can be varied according to the size of the particular guitar that is to be held in the stand 100. The scope of the present invention is also not limited to the various embodiments of stands being used with guitars. For example, embodiments of the present invention can be sized to hold other string instruments, such as violins, banjos, ukuleles, violas and basses. Embodiments of the present invention can also be sized to hold other types of musical instruments, as well as other objects, including various consumer products. Thus, embodiments of the present invention are not limited to the illustrated size, but, instead, the embodiments of the present invention can have various dimensions, depending upon the desired application.

What is claimed:

1. A stand for holding at least one musical instrument, comprising:
a base configured to rest on a surface and substantially support a musical instrument thereon; and
a support element that extends in a generally upward direction from the base, the support element further comprising a substantially articulated joint for mating with the musical instrument at various angular dispositions.

2. A stand for supporting at least one musical instrument, comprising:
a base configured to rest on a surface and substantially support a musical instrument thereon; and
a support neck having first and second ends, the first end being coupled to the base such that the second end extends in a generally upward direction, the second end further comprising a substantially articulated joint for magnetically mating with a ferrous or metallic element disposed on the musical instrument.

3. The stand of claim 2, wherein the ferrous or metallic element is removably mated to the musical instrument using at least one of: (i) a static charge polymer; and/or (ii) an adhesive.

4. A method for removably holding a musical instrument on a stand comprising a base configured to rest on a surface and substantially support a musical instrument thereon, and a support element extending in a generally upward direction, the support element further comprising a retention element for mating with the musical instrument, the method comprising:
disposing a removable complementary retention element on the musical instrument; and
disposing the instrument on the stand so that the retention element of the stand and the complementary retention element on the instrument mate to one another, thereby holding the instrument substantially in place on the stand.

5. The method of claim 4, wherein the retention element comprises a magnet, and the complementary retention element comprises a material which is attracted to the magnet by way of a magnetic field.

6. The method of claim 5, wherein the complementary retention element is removably mated to the musical instrument using at least one of: (i) a static charge polymer; and/or (ii) an adhesive.
